(19) United States
(12) Patent Application Publication
(10) Pub. No.: US 2026/0179187 A1
(43) Pub. Date: Jun. 25, 2026

(54) IMAGE ENHANCEMENT DEVICE AND IMAGE ENHANCEMENT METHOD FOR PROCESSING REGION OF INTEREST

(71) Applicant: SigmaStar Technology Ltd., Xiamen (CN)

(72) Inventors: Ran Lei CAO, Shanghai (CN); Yan Ni ZHANG, Shanghai (CN); Chang Yi CHANG, Taiwan (TW)

(21) Appl. No.: 19/405,694

(22) Filed: Dec. 2, 2025

(30) Foreign Application Priority Data
Dec. 19, 2024 (CN) 202411884191.2

(51) Int. Cl. G06T 5/50; G06T 5/20; G06T 5/60; G06T 7/70; G06V 10/25; G06V 10/82; G06V 20/62; G06V 40/16

(52) U.S. Cl. CPC G06T 5/50; G06T 5/20; G06T 5/60; G06T 7/70; G06V 10/25; G06V 20/625; G06V 40/161; G06T 2207/20084; G06T 2207/20221; G06T 2207/30201; G06V 10/82; G06V 2201/08

(57) ABSTRACT

An image enhancement device includes a preprocessing circuit, an intelligent processor and a processor. The preprocessing circuit preprocesses input image data to generate first image data. The intelligence processor detects at least one region of interest in the first image data to generate at least one set of original region data, and enhances image quality of the at least one set of original region data to generate at least one set of enhanced region data. The processor mixes the at least one set of original region data and the at least one set of enhanced region data according to a blending ratio to generate at least one set of mixed region data, and replaces the at least one region of interest in the first image data with the at least one set of mixed region data to generate output image data.

This application claims the benefit of China application Serial No. CN202411884191.2, filed on Dec. 19, 2024, the subject matter of which is incorporated herein by reference.

### BACKGROUND OF THE INVENTION

### Field of the Invention

The present application relates to an image enhancement device, and more particularly to an image enhancement device and an image enhancement method capable of enhancing image quality of a region of interest in an image.

### Description of the Related Art

In current monitoring applications, when a camera captures an image of an object to be detected, an image processing device usually enhances the image quality of the entire image for a user to better view a clearer image and identify the detected object. However, the approach above involves frame-by-frame and pixel-by-pixel calculations, resulting in overly large amounts of the overall calculation as well as potentially inaccurate effects in image quality enhancement.

### SUMMARY OF THE INVENTION

In some embodiments, it is an object of the present application to provide an image enhancement device and an image enhancement method capable of enhancing image quality of a region of interest in an image so as to improve the issues of the prior art.

In some embodiments, an image enhancement device includes a preprocessing circuit, an intelligence processor and a processor. The preprocessing circuit preprocesses input image data to generate first image data. The intelligence processor detects at least one region of interest in the first image data to generate at least one set of original region data, and enhances image quality of the at least one set of original region data to generate at least one set of enhanced region data. The processor mixes the at least one set of original region data and the at least one set of enhanced region data according to a blending ratio to generate at least one set of mixed region data, and replaces the at least one region of interest in the first image data with the at least one set of mixed region data to generate output image data.

In some embodiments, an image enhancement method performed by an image enhancement device includes operations of: preprocessing input image data to generate first image data; detecting at least one region of interest in the first image data to generate at least one set of original region data, and enhancing image quality of the at least one set of original region data to generate at least one set of enhanced region data; and mixing the at least one set of original region data and the at least one set of enhanced region data according to a blending ratio to generate at least one set of mixed region data, and replacing the at least one region of interest in the first image data with the at least one set of mixed region data to generate output image data.

Features, implementations and effects of the present application are described in detail in preferred embodiments with the accompanying drawings below.

In current monitoring applications, when a camera captures an image of an object to be detected, an image processing device usually enhances the image quality of the entire image for a user to better view a clearer image and identify the detected object. However, the approach above involves frame-by-frame and pixel-by-pixel calculations, resulting in overly large amounts of the overall calculation as well as potentially inaccurate effects in image quality enhancement.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of an image enhancement device according to some embodiments of the present application;

FIG. 2 is a flowchart of related operations of the image enhancement device in FIG. 1 according to some embodiments of the present application;

FIG. 3 is a schematic diagram of an operation to generate the at least one set of original region data in FIG. 1 according to some embodiments of the present application;

FIG. 4 is a schematic diagram of an operation to generate the at least one set of enhanced region data in FIG. 1 according to some embodiments of the present application; and

FIG. 5 is an operation flowchart of an image enhancement method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

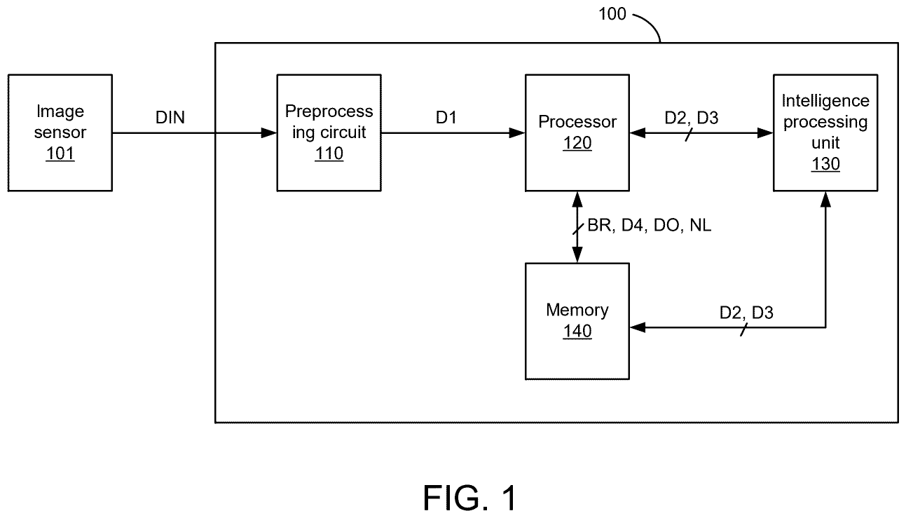

FIG. 1 shows a schematic diagram of an image enhancement device 100 according to some embodiments of the present application. In some embodiments, the image enhancement device 100 is capable of enhancing image quality of at least one region of interest (ROI) in image data to provide more reliable monitoring applications.

In some embodiments, the image enhancement device 100 may include a preprocessing circuit 110, a processor 120, an intelligence processing unit (IPU) 130 (also referred to as an intelligence processor) and a memory 140. The preprocessing circuit 110 may receive input image data DIN from an image sensor 101 (for example but not limited to, a camera), and preprocess the input image data DIN to generate image data D1. In some embodiments, the preprocessing may include, such as but not limited to, image scaling and image color domain conversion. In some embodiments, the preprocessing circuit 110 may be implemented by an image processing circuit.

The processor 120 may store the image data D1 to the memory 140. The intelligence processing unit 130 may detect at least one region of interest in first image data D1 to generate at least one set of original region data D2, and enhance image quality of the at least one set of original region data D2 to generate at least one set of enhanced region data D3. In some embodiments, the processor 120 is a processor in general-purpose architecture, and is capable of executing an extensive range of calculation tasks. In contrast, the intelligence processing unit 130 is a processor in dedicated architecture, may be used for parallel processing of a large-scale machine learning model and optimization for matrix operations and/or tensor operations, and is primarily for executing tasks associated with artificial intelligence models (and/or neural network models).

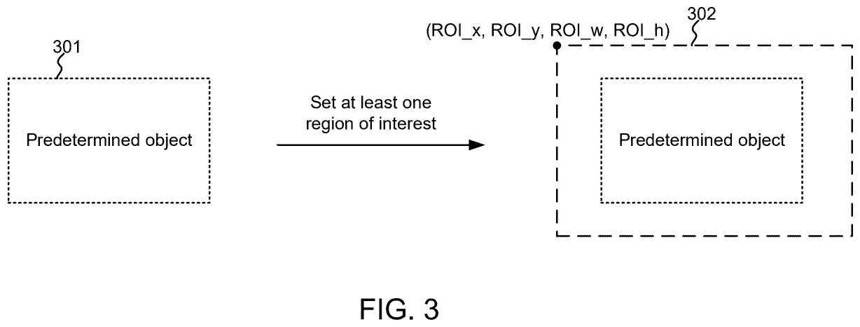

For example, the intelligence processing unit 130 may execute a neural network model for detecting at least one predetermined object, so as to detect whether the at least one predetermined object exists in the image data D1. In some embodiments, the at least one predetermined object may include, for example but not limited to, a human face, a vehicle license plate, or at least one of the above. The neural network model may be pre-trained by mass data and be stored in the memory 140, such that the intelligence processing unit 130 may access the memory 140 to execute the neural network model to detect whether the predetermined object exists in the image data D1. If the at least one predetermined object is detected to exist in the image data D1, the intelligence processing unit 130 may set at least one region of interest according to the position of the at least one predetermined object in the image data to generate the at least one set of original region data D2. Operation details associated with the setting of the at least one region of interest are to be described with reference to FIG. 3 below. In some embodiments, the neural network model may be implemented by a depthwise separable convolutions neural network so as to reduce the operation amount.

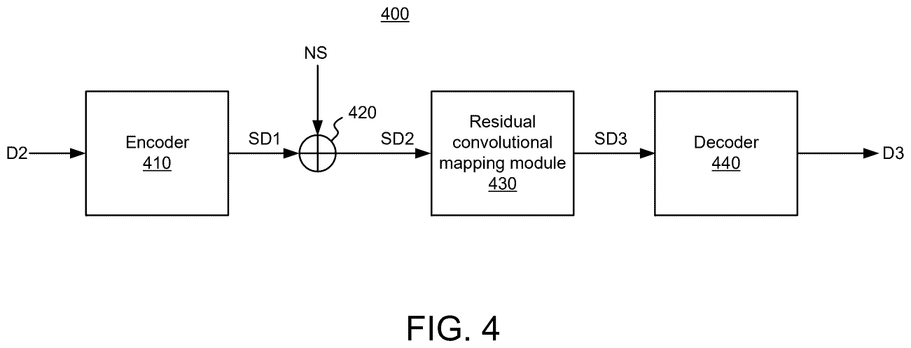

Next, the intelligence processing unit 130 may execute a variational auto-encoder to process the at least one set of original region data D2 to enhance the image quality of the at least one set of original region data D2 and accordingly generate the at least one set of enhanced region data D3. In some embodiments, the variational auto-encoder may be implemented by a neural network model and be stored in advance in the memory 140, such that the intelligence processing unit 130 may access the memory 140 to execute the neural network model. A related example associated with the variational auto-encoder is to be described with reference to FIG. 4 below. In some embodiments, the memory 140 may be, for example but not limited to, a dynamic random access memory (DRAM).

The processor 120 may mix the at least one set of original region data D2 and the at least one set of enhanced region data D3 according to a blending ratio BR to generate at least one set of mixed region data D4, and replace the at least one region of interest with the at least one set of mixed region data D4 to generate output image data DO. In other words, the processor 120 may mix the at least one set of enhanced region data D3 with enhanced image quality and the at least one set of original region data D2 corresponding to the at least one region of interest, and accordingly replace corresponding data contents of the at least one region of interest in the image data D1. Thus, the image quality of the at least one region of interest including the at least one predetermined object can be enhanced, and at the same time the output image data DO having been enhanced is prevented from appearing unnatural. In some embodiments, parameters of the blending ratio BR may be stored in the memory 140.

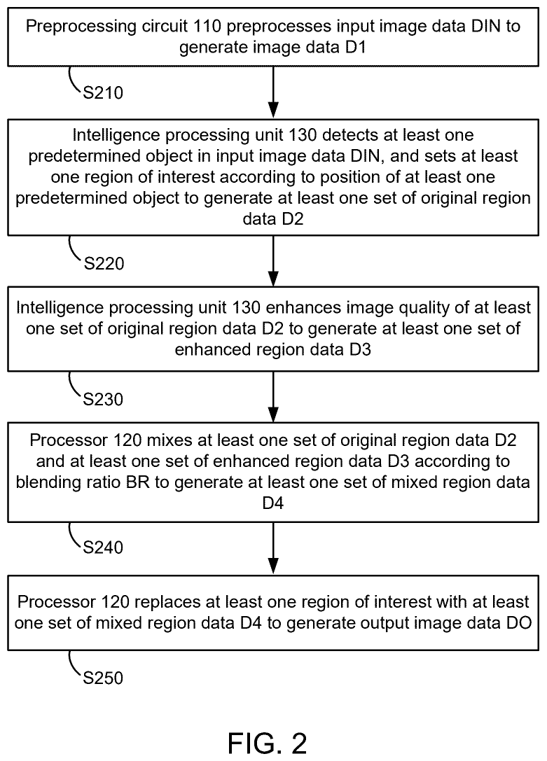

FIG. 2 shows a flowchart of related operations of the image enhancement device in FIG. 1 according to some embodiments of the present application. In operation S210, the preprocessing circuit 110 preprocesses the input image data DIN to generate the image data D1. In operation S220, the intelligence processing unit 130 detects the at least one predetermined object in the image data D1, and sets at least one region of interest according to the position of the at least one predetermined object to generate the at least one set of original region data D2.

To better describe operation S220, refer to FIG. 3 showing a schematic diagram of an operation to generate the at least one set of original region data D2 in FIG. 1 according to some embodiments of the present application. As described above, the intelligence processing unit 130 may execute a pre-trained neural network model to detect whether the at least one predetermined object exists in the image data D1. As shown in FIG. 3, if the intelligence processing unit 130 determines that a predetermined object (for example, a vehicle license plate) exists in the image data D1, the intelligence processing unit 130 may output coordinates of a boundary box 301 corresponding to the predetermined object, wherein the format of the boundary box 301 is (x, y, w, h), where x and y are respectively the horizontal coordinate (for example, the coordinate in the horizontal direction) and the vertical coordinate (for example, the coordinate in the vertical direction) of a center of the predetermined object, and w and h are respectively the width and the height of the predetermined object.

Next, the intelligence processing unit 130 may convert the coordinate information of the boundary box 301 to set the at least one region of interest, such that the at least one region of interest is sufficient to completely include the predetermined object, and the predetermined object is located substantially in the center of the at least one region of interest. For example, as shown in FIG. 3, the intelligence processing unit 130 may set the coordinates of the upper-left corner of the at least one region of interest 302 as (ROI_x, ROI_y, ROI_w, ROI_h), where ROI_x and ROI_y are respectively the horizontal coordinate and the vertical coordinate of the upper-left corner of the at least one region of interest 302, and ROI_w and ROI_h are respectively the width and the height of the at least one region of interest 302. In some embodiments, the values of ROI_w and ROI_h may be adjusted according to different predetermined objects to be detected. For example, if the predetermined object to be detected is a human face, the values of ROI_w and ROI_h may be set to 128; alternatively, if the predetermined object to be detected is a vehicle license plate, the values of ROI_w and ROI_h may be set to 256. It should be noted that numerical values above are merely examples, and the present application is not limited to such examples.

In some embodiments, the value of the horizontal coordinate ROI_x may be set to be a lesser one between a first value and a second value, the first value may be a difference between the horizontal coordinate x of the predetermined object and a half of the width (for example, w/2) of the predetermined object, and the second value may be a difference between the horizontal coordinate x of the predetermined object and a half of the width (for example, ROI_w/2) of the at least one region of interest 302. The setting above may be described as the mathematical equation below: ROI_x=min(x−w/2, x−ROI_w/2). Similarly, in some embodiments, the value of the vertical coordinate ROI_y may be set to be a lesser one between a third value and a fourth value, the third value may be a difference between the vertical coordinate y of the predetermined object and a half of the height (for example, h/2) of the predetermined object, and the fourth value may be a difference between the vertical coordinate y of the predetermined object and a half of the height (for example, ROI_h/2) of the at least one region of interest 302. The setting above may be described as the mathematical equation below: ROI_y=min(y−h/2, y−ROI_h/2). With the settings above, the intelligence processing unit 130 can locate the predetermined object to be as close as possible to the middle position of the at least one region of interest 302, and accordingly output related information of the at least one region of interest 302 as the at least one set of original region data D2.

The operation details above are given by setting one region of interest corresponding to one predetermined object as an example. It should be understood that, if the predetermined object in the image data D1 exists in a plural number (for example, including multiple vehicle license plates, multiple human faces, or one or more vehicle license plates and/or one or more human faces at the same time), the intelligence processing unit 130 may generate multiple regions of interest and corresponding multiple sets of original region data by the operations above.

Referring to FIG. 2, in operation S230, the intelligence processing unit 130 enhances the image quality of the at least one set of original region data D2 to generate the at least one set of enhanced region data D3.

To better describe operation S230, refer to FIG. 4 showing a schematic diagram of an operation to generate the at least one set of enhanced region data D3 in FIG. 1 according to some embodiments of the present application. As described above, the intelligence processing unit 130 may execute a variational auto-encoder to enhance the image quality of the at least one set of original region data D2 and accordingly generate the at least one set of enhanced region data D3. As shown in FIG. 4, in some embodiments, a variational auto-encoder 400 may include an encoder 410, an adder 420, a residual convolutional mapping module 430 and a decoder 440. The intelligence processing unit 130 may input the at least one set of original region data D2 to the encoder 410, and map the at least one set of original region data D2 in the pixel space by the encoder 410 to a feature vector (denoted as at least one set of data SD1) in the variable space. The adder 420 may add a Gaussian noise NS to the at least one set of data SD1. The intelligence processing unit 130 may input an added result of the two above to the residual convolutional mapping module 430, which then generates an enhanced feature vector (denoted as at least one set of data SD2). Lastly, the intelligence processing unit 130 may input the at least one set of data SD2 to the decoder 440, and map the at least one set of data SD2 by the decoder 440 into the at least one set of enhanced region data D3 in the pixel space.

In some embodiments, each of the encoder 410, the residual convolutional mapping module 430 and the decoder 440 may be implemented by a neural network model consisting of operational layers such as multiple convolutional layers, a normalization layer and a non-linear activation function, and be executed by the intelligence processing unit 130. In some embodiments, since the encoder 410, the residual convolutional mapping module 430 and the decoder 440 are individually responsible for different functions, for example, the encoder 410 is responsible for mapping the image before enhancement from the pixel space to the feature space, the residual convolutional mapping module 430 is responsible for mapping features before enhancement to features after enhancement, and the decoder 440 is responsible for mapping the features after enhancement from the feature space back to the pixel space. Thus, the neural network models corresponding to the three above may be trained separately. In some embodiments, training processes of the neural network models corresponding to the three above may be implemented in a generative adversarial network (GAN) training mode, allowing these models to compete with one another to achieve better image quality enhancement.

In some embodiments, by adding the Gaussian noise NS to the image data, the variational auto-encoder 400 may train the residual convolutional mapping module 430 and the decoder 440 so as to remain able to reconstruct corresponding image data with clear image quality even when an image is under the influence of noise. Thus, the reliability and versatility of the variational auto-encoder 400 in terms of image enhancement may be improved. In some embodiments, in actual applications, the residual convolutional mapping module 430 (and/or the adder 420) may be automatically activated under a condition of a poor shooting environment (for example but not limited to, a darker shooting scene or when a shooting scene is a rainy day), so as to improve the quality of a captured image.

Again referring to FIG. 2, in operation S240, the processor 120 mixes the at least one set of original region data D2 and the at least one set of enhanced region data D3 according to the blending ratio BR to generate the at least one set of mixed region data D4.

In some embodiments, the processor 120 determines a weighting coefficient according to a total number of layers NL of a transition zone and the blending ratio BR, and mixes the at least one set of original region data D2 and the at least one set of enhanced region data D3 according to the weighting coefficient to generate the at least one set of mixed region data D4. In some embodiments, the blending ratio BR may be any value ranging between value 0 and value 1 (including 0 and 1). In some embodiments, the transition zone may be a border region of the at least one region of interest, and the total number of layers NL of the transition zone indicates the degree by which the transition zone is divided. In other words, the transition zone is a region with gradual changes, and an edge of an image of the region of interest after enhancement gradually changes to an edge of an image of the original region of interest in the transition zone. A greater total number of layers NL of the transition zone represents a higher precision degree of the transition zone in a way that the change between each two layers is less, thereby rendering more natural image transition of the region of interest. In some embodiments, the generating of the at least one set of mixed region data D4 may be represented as an equation below:

$$\underline{D 4 = WR \times D 3 + ( 1 - WR ) \times D 2}$$

$$WR [ pw : w - 1 - i , ph : h - 1 - i ] = BR + \frac{BR}{NL \times ( NL - i - i )}$$

where the value w is the image width, the value h is the image height, the value WR is the weighting coefficient above, the value i is the number of layers of the current transition zone, each of the value pw and the value ph is i+1 for indicating a pixel position of the current transition zone, and NL is the (total) number of layers of the transition zone. It is seen from the equation above that, the weighting coefficient WR decreases as the number of layers i of the current transition zone increases. In this case, the processor 120 uses more of the at least one set of original region data D2 to mix with the image corresponding to the pixel position. Alternatively, the weighting coefficient WR increases as the number of layers i of the current transition zone decreases. In this case, the processor 120 uses more of the at least one set of enhanced region data D3 to mix with the image corresponding to the pixel position. That is, the weighting coefficient WR gradually changes in the transition zone, allowing the image contents in the region of interest to be presented in a smooth transition from an enhanced image to an original image. To explain from another perspective, by configuring the transition zone and the weighting coefficient WR, during image mixing, the processor 120 may use more of at least one set of original region data D2 in the pixel region of the region of interest close to the original image, and use more of the at least one set of enhanced region data D3 in the pixel region of the region of interest farther away from the original image, so as to prevent any noticeable boundaries at edges of the region of interest after mixing. In some embodiments, parameters of the total number of layers NL of the transition zone may be stored in the memory 140.

In operation S250, the processor 120 replaces the at least one region of interest with the at least one set of mixed region data D4 to generate the output image data DO. After generating the at least one set of mixed region data D4, the processor 120 may replace an image of the at least one region of interest in the image data D1 with an image of the at least one set of mixed region data D4, and accordingly generate the output image data DO. Thus, the image of the at least one region of interest in the output image data DO is an enhanced image having better image quality, allowing a user to view a clear monitoring image. In some embodiments, when provided with sufficient hardware computing abilities, the operations of the image enhancement device 100 above may also be extended to applications of real-time video streaming.

In some related art, an image processing device enhances the image quality of an entire image upon detecting the appearance of a predetermined object of interest. However, the approach above involves frame-by-frame and pixel-by-pixel calculations, and is compromised by having a large amount of calculation and inaccurate image quality enhancement. Compare to the prior art above, in some embodiments of the present application, upon detecting the appearance of a predetermined object of interest in an image, the image enhancement device 100 processes only image contents of the region of interest including the predetermined object, and uses a variational auto-encoder using a lesser amount of calculation to enhance the image quality of the region of interest. Thus, the clarity of the predetermined object of interest in an output image can be effectively improved while economizing system resources, enabling subsequent monitoring and identification applications to more conveniently and accurately analyze an output image.

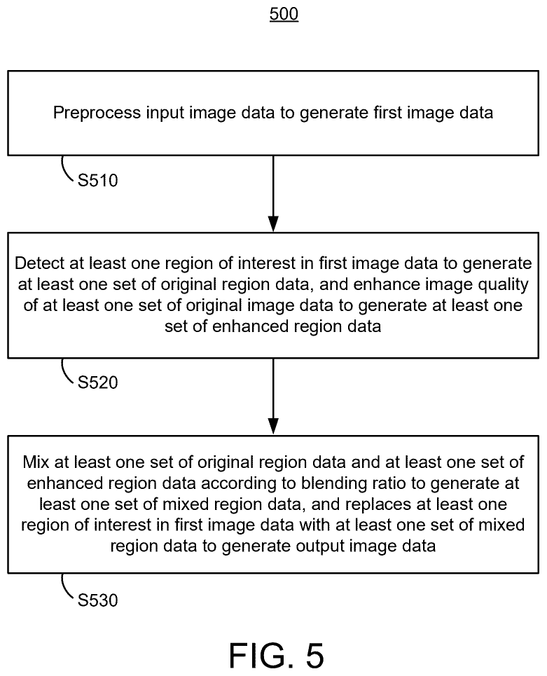

FIG. 5 shows an operation flowchart of an image enhancement method 500 according to some embodiments of the present application. In some embodiments, the image enhancement method 500 may be performed by, for example but not limited to, the image enhancement device 100 in FIG. 1.

In operation S510, input image data is preprocessed to generate first image data. In operation S520, at least one region of interest in the first image data is detected to generate at least one set of original region data, and image quality of the at least one set of original region data is enhanced to generate at least one set of enhanced region data. In operation S530, the at least one set of original region data and the at least one set of enhanced region data are mixed according to a blending ratio to generate at least one set of mixed region data, and the at least one region of interest in the first image data is replaced with the at least one set of mixed region data to generate output image data.

Details associated with the multiple operations of the image enhancement method 500 above can be referred from the details of the multiple embodiments above, and such repeated details are omitted herein. The multiple operations above are merely examples, and are not limited to being performed in the order specified in this example. Without departing from the operation means and ranges of the various embodiments of the present application, additions, replacements, substitutions or omissions may be made to the operations of the image enhancement method 500, or the operations may be performed in different orders. Alternatively, all or some of one or more the operations in the image enhancement method 500 may be performed simultaneously.

In conclusion, the image enhancement device and the image enhancement method according to some embodiments of the present application are capable of effectively enhancing the image quality of a region of interest while economizing system resources, thereby enhancing accuracy in subsequent monitoring applications (for example, face recognition and vehicle identification).

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. An image enhancement device, comprising:
a preprocessing circuit, preprocessing input image data to generate first image data;
an intelligence processor, detecting at least one region of interest in the first image data to generate at least one set of original region data, and enhancing image quality of the at least one set of original region data to generate at least one set of enhanced region data; and
a processor, mixing the at least one set of original region data and the at least one set of enhanced region data according to a blending ratio to generate at least one set of mixed region data, and replacing the at least one region of interest in the first image data with the at least one set of mixed region data to generate output image data.

2. The image enhancement device according to claim 1, wherein the intelligence processor executes a variational auto-encoder to enhance the image quality of the at least one set of original region data and generate the at least one set of enhanced region data.

3. The image enhancement device according to claim 2, wherein the intelligence processor inputs the at least one set of original region data to an encoder of the variational auto-encoder to generate at least one set of first data, inputs the at least one set of first data to a residual convolutional mapping module of the variational auto-encoder to generate at least one set of second data, and inputs the at least one set of second data to a decoder of the variational auto-encoder to generate the at least one set of enhanced region data.

4. The image enhancement device according to claim 3, wherein before the at least one set of first data is input to the residual convolutional mapping module, the intelligence processor further adds a Gaussian noise to the at least one set of first data by an adder of the variational auto-encoder.

5. The image enhancement device according to claim 1, wherein the intelligence processor detects at least one predetermined object in the first image data, and sets the at least one region of interest according to a position of the at least one predetermined object to generate the at least one set of original region data.

6. The image enhancement device according to claim 5, wherein a horizontal coordinate of coordinates of an upper-left corner of the at least one region of interest is set to be a lesser one between a first value and a second value, the first value is a difference between a horizontal coordinate of the at least one predetermined object and a half of a width of the at least one predetermined object, and the second value is a difference between the horizontal coordinate of the at least one predetermined object and a half of a width of the at least one region of interest.

7. The image enhancement device according to claim 5, wherein a vertical coordinate of coordinates of an upper-left corner of the at least one region of interest is set to be a lesser one between a first value and a second value, the first value is a difference between a vertical coordinate of the at least one predetermined object and a half of a height of the at least one predetermined object, and the second value is a difference between the vertical coordinate of the at least one predetermined object and a half of a height of the at least one region of interest.

8. The image enhancement device according to claim 5, wherein the at least one predetermined object comprises at least one of a human face and a vehicle license plate.

9. The image enhancement device according to claim 1, wherein the processor determines a weighting coefficient according to a total number of layers of a transition zone and the blending ratio, and mixes the at least one set of original region data and the at least one set of enhanced region data according to the weighting coefficient to generate the at least one set of mixed region data.

10. The image enhancement device according to claim 9, wherein the weighting coefficient gradually changes in the transition zone.

11. An image enhancement method, performed by an image enhancement device, the image enhancement method comprising:
preprocessing input image data to generate first image data;
detecting at least one region of interest in the first image data to generate at least one set of original region data, and enhancing image quality of the at least one set of original region data to generate at least one set of enhanced region data; and
mixing the at least one set of original region data and the at least one set of enhanced region data according to a blending ratio to generate at least one set of mixed region data, and replacing the at least one region of interest in the first image data with the at least one set of mixed region data to generate output image data.
